(19) United States
(12) Patent Application Publication
(10) Pub. No.: US 2014/0195171 A1
(43) Pub. Date: Jul. 10, 2014

(54) System and Method for Determining Flushing Frequency for Dead End Mains

(71) Applicant: Ivan Luna, Kingsville, TX (US)

(72) Inventor: Ivan Luna, Kingsville, TX (US)

(73) Assignee: City of Corpus Christi

(21) Appl. No.: 14/104,884

(22) Filed: Dec. 12, 2013

Related U.S. Application Data
(60) Provisional application No. 61/748,972, filed on Jan. 4, 2013.

(51) Int. Cl. G01M 99/00

(52) U.S. Cl. CPC G01M 99/00
USPC 702/33

(57) ABSTRACT

A system for determining a flushing frequency of a dead end main includes a user terminal in communication with a server. The server further includes memory and a processor in communication with the memory. A dead end main id, at least one disinfectant reading and at least one disinfectant reading of the dead end main are received from the user at the user terminal. The processor determines at least one flushing score of the dead end main based on the at least one disinfectant reading and a predetermined flushing score condition. The processor determines the flushing frequency of the dead end main based on the at least one flushing score and a predetermined flushing frequency condition.

### CROSS REFERENCE TO RELATED APPLICATIONS

This application claims priority to U.S. Provisional Application Ser. No. 61/748,972, tilted: “System and Method for Determining Flushing Frequency for Dead End Mains” filed on Jan. 4, 2013, entire contents of which are herein incorporated by reference.

### BACKGROUND

1. Field of the invention

The present invention relates generally to water distribution systems, and more specifically to monitoring of water quality to determine flushing frequency for dead end mains of water distribution systems.

Water supplied through a water distribution system of a city undergoes several qua control processes. One such quality control process involves checking disinfectant levels in water at various locations of the water distribution system. To ensure potability of water, disinfectant levels in water should be maintained at an optimum level. To maintain acceptable disinfectant levels, water at dead end mains in the water distribution system is checked, and if required, flushed.

Conventional water quality maintenance systems sample water at regular time intervals at various locations of the water distribution system to check the disinfectant levels and flush out water at locations where water has low disinfectant levels, or flush out water at set times. U.S. Pat. No. 6,035,704 by Michael R. Newman discloses an apparatus that checks the disinfectant levels in water at specific locations and flushes out water, if disinfectant levels fall below a required level. The apparatus includes a flow control valve coupled to a programmable electronic circuitry that controls the flow of water in the apparatus therethrough. The apparatus also includes a microprocessor system that stores instructions for activating and deactivating the flow control valve, based on disinfectant levels in water. Another U.S. Pat. No. 6,001,254 by Espenan, et. al., discloses a method for backwashing a group of filter membranes with water to verify the working of the filter membranes. The permeability of water being let out of each filter membrane is compared with ideal permeability values to detect anomalies in the operation of the filter membrane. The permeability values are also used to modify the periodicity of backwashing of the filter membranes.

Periodic flushing of water, for example as required by Texas state regulation 30TAC290.46 (1), results is wastage of a large quantity of water. It is desirable that a water quality control method be efficient in reducing the amount of water flushed, wherever possible. It is of great importance to enforce a water flushing system that strikes a balance between water conservation and water quality.

Therefore, it would be advantageous to have a system and method for determining a flushing frequency of water at a dead end main, which does not result in unnecessary wastage of water. In spite of monitoring systems known in the art, a need continues to exist for a simple, economical monitoring system for determining the periodicity of flushing of dead end mains.

### SUMMARY

An object of the present invention is to provide a system and method for determining a flushing frequency of a dead end main of a water distribution.

Another object of the present invention is to provide a system and method for determining a flushing frequency of a dead end main of a water distribution that strikes a balance between water conservation and water quality.

In an embodiment of the present invention, a computer implemented method for determining a flushing frequency of a dead end main in a water distribution system is provided. The method is executed by a processor in communication with a memory. A dead end main id and at least one disinfectant reading are received at the processor. The flushing score of the dead end main is determined by locating the nearest fire hydrant, or appurtenance (referred to herein as a dedicated flushing point or location having a service connection, or a spicket, etc.) to the dead end main area and the flushing frequency of the dead end main is determined based on the number of times the dead end main has accumulated a good reading. A good reading is given if predetermined initial disinfectant conditions are met.

In another embodiment of the present invention, a system for determining a flushing frequency of a dead end main in a water distribution system is provided. The system includes at least one user terminal and a server in communication with the at least one user terminal. The server includes a processor in communication with a memory. A dead end main id, at least one disinfectant reading and at least one month of sampling corresponding to the dead end main are received at the processor. At least one flushing score of the dead end main is determined based on the at least one disinfectant reading and a predetermined flushing score condition. The flushing frequency of the dead end main is determined based on a sum of the at least one flushing score and a predetermined flushing frequency condition.

### BRIEF DESCRIPTION OF DRAWINGS

The features of the present invention, which are believed to be novel, are set forth with particularity in the appended claims. Embodiments of the present invention will hereinafter be described in conjunction with the appended drawings provided to illustrate and not to limit the scope of the claims, wherein like designations denote like elements, and in which:

FIG. 1 is a schematic diagram of a water distribution system. wherein various embodiments of the present invention can be practiced;

FIG. 2 is a schematic block diagram of the system for determining a flushing frequency for a dead end main of the water distribution system of FIG. 1, in accordance with an embodiment of the present invention;

FIG. 3A is a graphical representation of a point system used to convert a disinfectant reading of a dead end main into a flushing score of the dead end main, in accordance with an embodiment of the present invention;

FIG. 3B is a graphical representation of a point system used to determine an initial flushing frequency of a dead end main, in accordance with an embodiment of the present invention;

FIG. 3C is a graphical representation of a point (also called here flushing score) system for determining a change in the flushing frequency of a dead end main, in accordance with an embodiment of the present invention;

FIG. 4A is a table that illustrates the disinfectant readings of the dead end main ‘1212’, recorded twice every month from September 2011 to January 2012, in accordance with an embodiment of the present invention;

FIG. 4B is a table that illustrates the disinfectant readings of the dead end main ‘1212’, recorded from February 2012 to March 2012, in accordance with an embodiment of the present invention;

FIG. 5A is a table that illustrates the disinfectant readings of the dead end main ‘1000’, recorded twice every month from September 2011 to January 2012, in accordance with an embodiment of the present invention;

FIG. 5B is a table that illustrates the disinfectant readings of the dead end main ‘1000’, recorded from February 2012 to March 2012, in accordance with an embodiment of the present invention; and

FIG. 6 is a flowchart that depicts a method for determining a flushing frequency for a dead end main in a water distribution system, in accordance with an embodiment of the present invention,

### DETAILED DESCRIPTION OF THE INVENTION

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention.

There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of method steps and system components related to computer-implemented method for determining a flushing frequency of a dead end main for a water distribution system. Accordingly, the system components and the method steps have been represented where appropriate by conventional symbols in the drawings, showing only specific details that are pertinent for an understanding of the present invention so as not to obscure the disclosure with details that will be readily apparent to those with ordinary skill in the art having the benefit of the description herein.

While the specification concludes with the claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

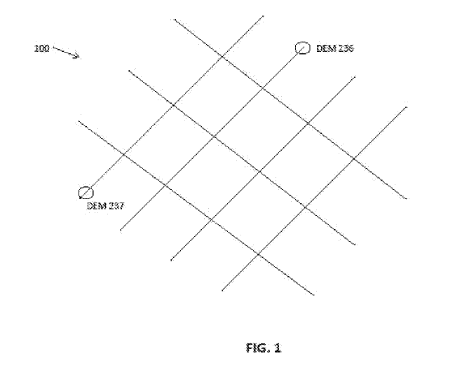

Referring now to FIG. 1, a schematic diagram of a water distribution system, wherein various embodiments of the present invention can be practiced, is shown. The water distribution system 100 may be a traditional underground water distribution system, such as a residential or commercial water distribution system in a city. The water distribution system 100 includes a web of interconnected pipes that are used to supply water to different parts of the city. The water distribution system 100 includes dead end mains at various locations. Dead end mains are the locations of the water distribution system where a pipe ends or is capped off, and contains standing or non-moving water. Per regulatory requirements, this standing water is required to be flushed at predetermined periodic intervals such as, once a month, to avoid or minimize bacterial or other contaminates forming in the dead end main. In various embodiments of the present invention, different parameters, such as the length of a pipe of water distribution system and a diameter of the pipe of the water distribution system 100 are used to identify one or more pipes of the water distribution system 100 as a dead end main (DEM).

In an embodiment of the present invention, one or more pipes of the water distribution system 100 with a diameter of 4 inches and a length of at least 100 feet are identified as dead end mains. The dead end mains of the water distribution system 100 are fitted with hydrants to enable flushing of water. In another embodiment of the present invention, cul-de-sacs of the water distribution system 100 are identified as the dead end mains, The dead end mains are periodically sampled to analyze the disinfectant levels in water. In FIG. 1, for example, DEM 236, and DEM 237, refer to various dead end mains of the water distribution system 100. Chloramines are used as a common disinfectant in the water distribution system. The disinfectant level at the dead end main after each periodic sampling is used to determine a frequency of flushing of the dead end main.

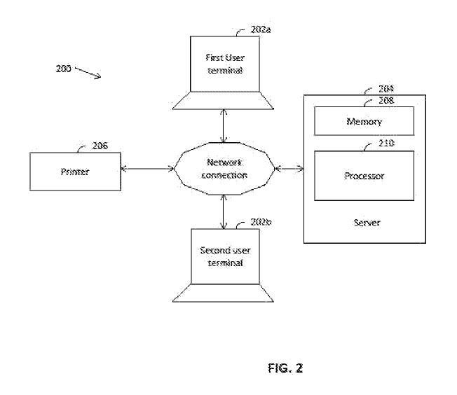

Referring now to FIG. 2, a schematic block diagram of the system for determining a flushing frequency for a dead end main of the water distribution system of FIG. 1, in accordance with an embodiment of the present invention, is shown. The system 200 includes a plurality of user terminals, such as first and second user terminals 202a and 202b (collectively referred to as user terminal 202), a server 204 in communication with the user terminal 202, and a printer 206 connected to the user terminal 202 and the server 204 through a network connection. The server 204 includes a memory 208 and a processor 210. Each dead end main of the water distribution system 100 is sampled periodically. Periodic readings of the disinfectant levels of each dead end main are entered into the system 200 through the user terminal 202 and are stored in the memory 208. A set of parameters corresponding to each dead end main of the water distribution system 100 is stored in the memory 208. This set of parameters is referred to as the flushing parameters.

Each dead end main has a separate set of flushing parameters associated with it, which is stored in the memory 208. The flushing parameters of a dead end main include dead end main id, month of sampling, disinfectant reading for the corresponding month of sampling, flushing score, and flushing frequency. Other parameters may be evaluated and are dependent upon the information desired to review by a user. Dead end main id is a unique id used to designate a dead end main of the water distribution system. Month of sampling is the month in which dead end main is sampled. Disinfectant reading is the measure of the disinfectant found in the water sample. Disinfectant reading is measured in milligrams per liter (mg/l). Flushing frequency is the frequency of flushing of the dead end main. In an embodiment of the present invention, a dead end main of the water distribution system 100 may be flushed twice a month, once a month, once every two months, and once every three months. Flushing score refers to an integer value obtained after converting the disinfectant reading based on a point system. The flushing parameters are entered by a user at the user terminal 202 and stored in the memory 208. In an embodiment of the present invention, the flushing parameters are stored in a database implemented using structured query language (SQL). In another embodiment of the present invention, Microsoft Access database is used to store the flushing parameters.

In yet a further embodiment of the present invention, the memory 208 stores additional flushing parameters pertaining to a dead end main, which may include worker id of a worker who performed the sampling or flushing, work order id, time of sampling or flushing, temperature at the time of sampling or flushing, and last date at which flushing or sampling was done at the dead end main.

The flushing parameters of a dead end main are added or updated after each sampling of the dead end main. After each sampling of the dead end main, the user enters a disinfectant reading, and the month of sampling of the dead end main at the user terminal 202. The processor 210 then determines the flushing score corresponding to each combination of the month of sampling and the disinfectant reading and stores it in the memory 208. Thus, for each dead end main id stored in the memory 208, multiple values of disinfectant reading, flushing score and the corresponding month of sampling are stored. Table A below shows the chlorine disinfectant readings and the corresponding flushing scores of the dead end main 1000 from January to May.

TABLE A
Disinfectant readings for dead end main 1000 from January till May

| | Dead end main id 1000 | | | | |
|---|---|---|---|---|---|
| | January | February | March | April | May |
| Disinfectant | 3.1 mg/L | 0.28 mg/L | 1.2 mg/L | 3.3 mg/L | 2.8 mg/L |
| readings | | | | | |
| Flushing | 1 | 8 | 4 | 1 | 2 |
| score | | | | | |

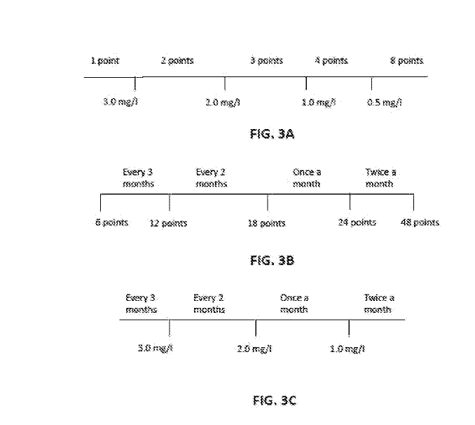

FIG. 3A, is a graphical representation of a point system used to convert a disinfectant reading of a dead end main into a flushing score of the dead end main, in accordance with an embodiment of the present invention. The processor 210 compares the disinfectant reading of the dead end main obtained after each periodic sampling against the point system illustrated in FIG. 3A. If the disinfectant reading of the dead end main is less than 1.0 mg/l, the processor 210 assigns a flushing score of 4. If the disinfectant reading is between 1.0 mg/l and 2.0 mg/l, the flushing score is 3. if the disinfectant reading is between 2.0 mg/1 and 3.0 the flushing score is 2. if the disinfectant reading is greater than 3,0 mg/l, the flushing score is 1. When a system contains monochloramines, 0.5 mg/I is the regulatory lower limit of acceptability, and the flushing score is 8.

To determine the flushing frequency of a dead end main, the processor 210 converts the past disinfectant readings of the dead end main into corresponding flushing score. In an embodiment of the present invention, disinfectant readings of the dead end main for last six months are considered to determine the flushing frequency of the dead end main.

Referring now to FIG. 3B, a graphical representation of a point system used to determine an initial flushing frequency of a dead end main, in accordance with an embodiment of the present invention, is shown. The initial flushing frequency of the dead end main refers to a first value of flushing frequency assigned to the dead end main, based on disinfectant readings of past six months. The point system illustrated in FIG. 3A is used to calculate a flushing score corresponding to each disinfectant reading of the dead end main for the last six months. The processor 210 calculates a sum of the flushing scores corresponding to the disinfectant readings of the dead end main for the last six months. If the sum is between 6 points and 12 points, the flushing frequency of the dead end main is determined as ‘once in every three months’. If the sum is between 12 and 18 points, the flushing frequency is ‘once in every 2 months’. if the sum is between 18 and 24 points, the flushing frequency is ‘once a month’. If the sum is between 24 and 48, the flushing frequency is ‘twice a month’. Once the flushing frequency of the dead end main is determined, the processor 210 stores it in the memory 208.

After an initial assignment of the flushing frequency of the dead end main, the processor 210 monitors the subsequent disinfectant readings and determines the corresponding flushing scores. In case of any change in a flushing score of a dead end main as compared to the flushing score of the dead end main for the previous sampling, the processor 210 uses a point system to determine if a change in the flushing frequency of the dead end main is required.

Referring now to FIG. 3C, a graphical representation of a point system for determining a change in the flushing frequency of a dead end main, in accordance with an embodiment of the present invention, is shown. In an embodiment of the present invention, the dead end main is sampled once every month. In case of a decrease in a current disinfectant reading with respect to the disinfectant reading of the previous sampling of the dead end main, the flushing score of the current disinfectant reading is determined and the processor 210 changes the flushing frequency of the dead end main according to the point system illustrated in conjunction with FIG. 3A.

In case there is an increase in a disinfectant reading with respect to the disinfectant reading of the previous sampling, no change in the flushing frequency is made. The processor 210 monitors the disinfectant reading for subsequent samplings. If the disinfectant reading of the dead end main is greater than 1.0 mg/l for eight consecutive sampling instances, the processor 210 changes the flushing frequency of the dead end main from twice a month to once a month. If the disinfectant reading is greater than 2.0 mg/I for four consecutive sampling instances, the processor 210 changes the flushing frequency of the dead end main from once a month to once every 2 months. If the disinfectant reading is greater than 3.0 mg/l for two consecutive sampling instances, the processor 210 changes flushing frequency of the dead end main from once every 2 months to once every 3 months.

In summary, changes to the flushing frequency will be made based on the flushing score obtained and the point system described. The inventive system is dynamic and flushing of the DEMs changes based on their water quality. The current system described can be used for any type of monitoring program for various chemical elements requiring flushing of pipes or systems in general. The present invention calls for a balance between water quality and water conservation. Other types of balances can be addressed with the invention described. The point system can be modified for a particular element and flushing frequency needed or desired.

The processor 210 generates various reports of the flushing of the dead end mains of the water distribution system, based on user requirements and the flushing parameters of the dead end mains stored in the memory 208. Examples of reports include a list of dead end mains with a flushing frequency of once a month, a list of dead end mains that are scheduled to be flushed in a day and a list of dead end mains whose disinfectant readings decreased with respect to a previous disinfectant reading. Table B below shows an exemplary report that provides a list of dead end mains for which disinfectant readings for the month of may have decreased over their previous disinfectant readings for the month of April.

TABLE B
Disinfectant readings

| | Disinfectant readings for | Disinfectant readings for |
|---|---|---|
| Dead end main id | April (mg/L) | May (mg/L) |
| 2000 | 3.1 | 2.3 |
| 3000 | 2.5 | 1.8 |
| 4000 | 1.7 | 0.9 |
| 5000 | 3.4 | 1.3 |

In an embodiment of the present invention, the processor 210 generates a list of dead end mains to be flushed each day, based on the flushing frequencies of the dead end mains, and sends the list of dead end mains to the user terminal 202. At the user terminal 202, the task of flushing of the dead end mains is assigned to workers. In another embodiment of the present invention, the processor 210 may directly assign a worker to a dead end main that needs to be flushed for the day and send the details of the dead end main to be flushed to the printer 206 thereafter. The worker may retrieve the printed information from the printer 206. The assignment of a worker is done with the help of a worker database that contains details corresponding to the available workers.

in another embodiment of the present invention, the system 200 is implemented using batch programming. At periodic intervals, for example, bimonthly a batch of tasks to be done by the system 200 is implemented as a predefined set of instructions to be executed by the processor 210, requiring manual intervention only to assign workers for the flushing and sampling exercises. The batch of tasks include retrieving a list of dead end mains to be flushed, retrieving a list of dead end mains to be sampled, receiving and storing disinfectant readings of the dead end mains after sampling and determining flushing scores of the dead end mains upon storing the disinfectant readings after sampling.

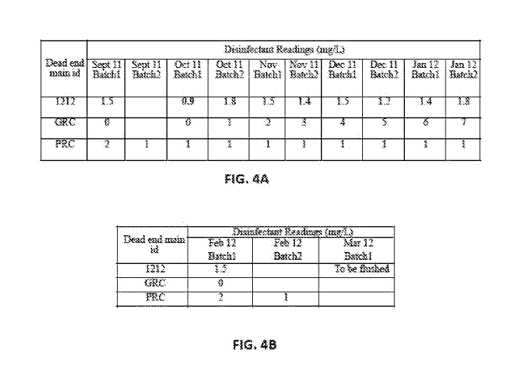

Referring now to FIG. 4A, a table that illustrates the disinfectant disinfectant readings of the dead end main ‘1212’, sampled twice every month from September 2011 to January 2012, in accordance with an embodiment of the present invention is shown. In an embodiment of the present invention, the processor 210 determines the initial flushing frequency of dead end main ‘1212’ as ‘once a month’. ‘G-RC’ stands for Good Reading Count of a dead end main. For each month, when the current disinfectant reading of a dead end main is greater than the previous disinfectant reading of the dead end main, one point is added to the GRC of the dead end main, which is shown in FIG. 4A for ‘1212’. Print Range Count (PRC)-DEFINE, In the month of October 2011, ‘1212’ is sampled and the disinfectant reading is recorded as 0.9 mg/L, which is less than 1 mg/L. Subsequently, the processor 210 changes the flushing frequency of ‘1212’ from ‘once a month’ to ‘twice a month’.

Referring now to FIG. 4B, a table that illustrates the disinfectant readings of the dead end main ‘1212’, sampled in February 2012, in accordance with an embodiment of the present invention is shown. The disinfectant reading of ‘1212’ for the months from November 2011 to February 2012 is above 1 mg/L. Since ‘1212’ has recorded disinfectant readings greater than 1 mg/L, for four consecutive months from November 2011 to February 2012, the processor 210 changes the flushing frequency of ‘1212’ front ‘twice a month’ to ‘once a month’.

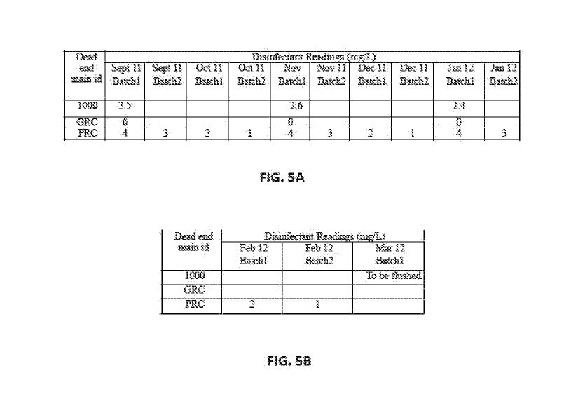

Referring now to FIG. 5A, a table that illustrates the disinfectant readings of the dead end main ‘1000’, sampled twice every month front September 2011 to January 2012, in accordance with an embodiment of the present invention is shown. The processor 210 determines an initial flushing frequency of ‘Every 2 months’ for dead end main ‘1000’. The disinfectant readings of ‘1000’ for the months from September 2011 to January 2012 are between 2.0 mg/L and 3.0 mg/L as shown in FIG. 5A.

Referring now to FIG. 58, a table that illustrates the disinfectant readings of the dead end main ‘1000’, sampled twice every month in February 2012, in accordance with an embodiment of the present invention is shown. The disinfectant reading of ‘1000’ for the month of February 2012 is also between 2.0 mg/L and 3.0 mg/L. Hence, the processor 210 does not change the flushing frequency and GRC of the dead end main ‘1000’. All results presented herein were based on field testing data. Instrumentation for field testing used for analysis was Hach DR 850. Data was obtained by colorimetry methodology.

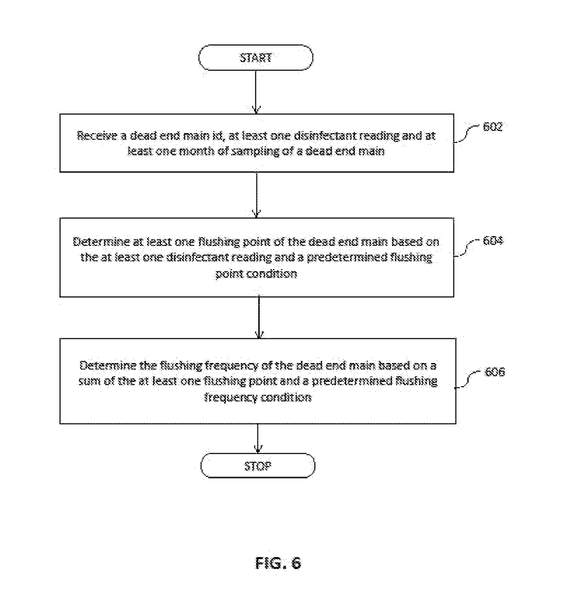

Referring now to FIG. 6, a method for determining a flushing frequency of a dead end main of the water distribution system 100, in accordance with an embodiment of the present invention, is shown. Steps of FIG. 6 are explained in conjunction with the description of FIG. 1, FIG. 2 and FIGS. 3A-3C. At step 602, a dead end main id, month of sampling and a disinfectant reading of the dead end main are received from the user at the user terminal 202 and stored in the memory 208. At step 604, a flushing score of the dead end main is determined based on a sum of at least one of a plurality of disinfectant readings of the dead end main, as illustrated in conjunction with FIG. 3A. The flushing score, on a scale of 1 to 8, is calculated based on the disinfectant reading of the dead end main. At step 606, based on the flush score, the flushing frequency of the dead end main is determined as described in conjunction with FIG. 3B. The determined flushing frequency is then stored in the memory 208. The flushing score corresponding to the subsequent disinfectant readings are monitored and in case of a change in the flushing score, the flushing frequency is changed accordingly, as described in FIG. 3C.

A further embodiment of the invention includes the to monitor elements other than chlorine. The elements to monitor can be whatever is needed by the user. The inventive monitoring program herein is not limited to performing the monitoring on the timelines as noted but can be performed at the user's discretion with more or less than a monthly monitoring timeline. Further embodiments include having application(s) on a mobile device that interact with the system 200 so as a worker can remotely enter data or other relevant information without the need for being before terminal 200. In general, the various embodiments of the present invention may be implemented in hardware or special purpose circuits, software, logic, or any combination thereof. For example, some aspects may be implemented in hardware, while other aspects may be implemented in firmware or software which may be executed by a processor, such as a controller, microprocessor or other computing device, although the invention is not limited thereto. While various aspects of the invention may be illustrated and described as block diagrams or flow charts, it will be understood that these blocks, apparatus, systems, techniques or methods described herein may be implemented in, as non-limiting examples, hardware, software, firmware, special purpose circuits or logic, general purpose hardware or controller or other computing devices, or some combination thereof.

Thus, the present invention has been described herein with reference to a particular embodiment for a particular application, i.e., monitoring of chlorine in water found in DEMs. Although selected embodiments have been illustrated and described in detail, it may be understood that various substitutions and alterations are possible. Those having ordinary skill in the art and access to the present teachings may recognize additional various substitutions and alterations are also possible without departing from the spirit and scope of the present invention, and as defined by the following claims.

What is claimed is:

1. A computer implemented method for determining a flushing frequency of a dead end main in a water distribution system, wherein the method is executed by a processor in communication with a memory, the method comprising:
receiving a dead end main identification (id), at least one disinfectant reading and at least one disinfectant level corresponding to the dead end main at the processor;
determining at least one flushing score of the dead end main based on the at least one disinfectant reading and a predetermined flushing score condition; and
determining the flushing frequency of the dead end main based on a sum of the at least one flushing score and a predetermined flushing frequency condition.

2. The method of claim 1, further comprising storing the dead end main id, the at least one disinfectant reading, the at least one disinfectant level, the at least one flushing score, the predetermined flushing score condition, the predetermined flushing frequency condition and the flushing frequency of the dead end main.

3. The method of claim 2, further comprising altering the flushing frequency of the dead end main based on the at least one flushing score and the predetermined flushing frequency condition.

4. The method of claim 3 wherein the disinfectant is chlorine.

5. The system of claim 4 wherein the sum of the east one flushing score is between about 6 and about 48 points.

6. The system of claim 5 wherein the predetermined flushing score condition is between about or less than 0.5 mg/l and about or greater than 8.

7. A system for determining a flushing frequency of a dead end main in water distribution system, the system comprising:
at least one user terminal; and
a server, in communication with the at least one user terminal, the server including a processor in communication with a memory, wherein the processor is configured to perform steps including:
receiving a dead end main id, at least one disinfectant reacting and at least one disinfectant reading corresponding to the dead end main;
determining at least one flushing score of the dead end main based on the at least one disinfectant reading and a predetermined flushing score condition; and
determining the flushing frequency of the dead end main based on a sum of the at least one flushing score and a predetermined flushing frequency condition.

8. The system of claim 7 wherein the processor is further configured for storing the dead end main id, the at least one disinfectant reading, the at least one disinfectant reading, the at least one flushing score, the predetermined flushing score condition, the predetermined flushing frequency condition and the flushing frequency of the dead end main.

9. The system of claim 8, wherein the processor is further configured for altering the flushing frequency of the dead end main based on the at least one flushing score and the predetermined flushing frequency condition.

10. The system of claim 7 further comprising a printer connected to the at least one of the user terminal and the server through a network connection.

11. The method of claim 1 used in combination with a mobile application so as to allow a user remote access and entry to data of the dead end main.

12. The system of claim 7 used in combination with a mobile application so as to allow a user remote access and entry to data of the dead end main.

13. The system of claim 7 wherein the disinfectant is chlorine.

14. The system of claim 7 wherein the sum of the at least one flushing score is between about 6 and about 48 points.

15. The system of claim 7 wherein the predetermined flushing score condition is between about or less than 0.5 mg/l and about or greater than 8.
